(19) United States
(12) Patent Application Publication
(10) Pub. No.: US 2008/0042467 A1
(43) Pub. Date: Feb. 21, 2008

(54) MULTIPART ROOF FOR A MOTOR VEHICLE

(75) Inventors: Gernot Bruder, Karlsruhe (DE); Philipp Wolf, Stuttgart (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/839,965

(22) Filed: Aug. 16, 2007

(30) Foreign Application Priority Data
Aug. 19, 2006 (DE) 10 2006 039 014.8

(51) Int. Cl. B60J 7/08

(52) U.S. Cl. 296/108

(57) ABSTRACT

A multipart roof for a vehicle is adjustable on a vehicle body between a closed position and an opened position. The roof includes a front roof part and a rear roof part. The roof parts are movable via a lever such that in the opened position of the roof the front roof part assumes an upright position in a storage compartment of the vehicle. The lever includes a coupling gear having multiple gear elements to effect the open position of the roof parts. The gear elements are in mechanical linkage with the vehicle body and with the front roof part.

### CROSS-REFERENCE TO RELATED APPLICATIONS

This application claims foreign priority benefits under 35 U.S.C. § 119(a)-(d) to DE 10 2006 039 014.8, filed Aug. 19, 2006, which is hereby incorporated by reference in its entirety.

### BACKGROUND OF THE INVENTION

1. Field of the Invention

The present invention relates to a multipart vehicle roof movable between a closed position in which the roof parts cover the vehicle interior and an opened position in which the roof parts are stowed in an upright position in a storage compartment within the vehicle interior thereby exposing the vehicle interior.

2. Background Art

FR 2,694,245 describes a foldable vehicle roof having front, middle, and rear roof parts movable between a closed position in which the roof parts cover the vehicle interior and an opened position in which the roof parts are stowed in a storage compartment within the vehicle interior. A lever mechanism connects the middle roof part to the vehicle. The rear roof part has a bearing axis in its rear region. When the roof is moved from the closed position toward the opened position, the front roof part moves over the middle roof part. The lever mechanism then jointly lowers the front and middle roof parts causing them to assume an upright position in the storage compartment with the rear roof part which is also lowered about its bearing axis.

GB 1,159,790 describes a convertible vehicle roof having front, middle, and rear roof parts. Lateral legs connect the middle and rear roof parts to the vehicle body such that these roof parts are upright in the lowered state.

### SUMMARY OF THE INVENTION

An object of the present invention includes a foldable multipart vehicle roof which is movable between a closed position in which the roof parts cover the vehicle interior and an opened position in which the roof parts are stowed in an upright, package-like folded position in a storage compartment within the vehicle interior thereby exposing the vehicle interior in which a lever mechanism moves the roof in a targeted manner between the closed and opened positions such that a trunk lid of the vehicle trunk adjacent to the storage compartment is unaffected by the roof movement.

In carrying out the above object and other objects, the present invention provides a vehicle having a roof, a linear guide apparatus, and a lever mechanism. The roof has a front roof part and a rear roof part articulately connected together such that movement of the front roof part causes a corresponding movement of the rear roof part. The linear guide apparatus is fixed to the vehicle body within a storage compartment of the vehicle interior. The lever mechanism movably connects the front roof part to the linear guide apparatus to move the roof parts between a closed position in which the roof parts extend over and cover the vehicle interior and an opened position in which the roof parts are stowed in an upright, package-like folded position with their undersides meeting one another in the storage compartment thereby exposing the vehicle interior. The lever mechanism includes a coupling gear having first, second, third, and fourth gear elements forming a four-bar kinematic linkage system in mechanical linkage with the front roof part and the linear guide apparatus, wherein the first gear element is supported on the front roof part, the second and third gear elements extend between the front roof part and the fourth gear element, and the fourth gear element slidably engages the linear guide apparatus to be movable between an upper position corresponding to the roof being in the closed position and a lower position corresponding to the roof being in the opened position.

Further, in carrying out the above object and other objects, the present invention provides a vehicle having a roof and a lever mechanism. The roof includes a front roof part and a rear roof part articulately connected together such that movement of the front roof part causes a corresponding movement of the rear roof part. The lever mechanism movably connects the front roof part to the vehicle body to move the roof parts between a closed position in which the roof parts extend over and cover the vehicle interior and an opened position in which the roof parts are stowed in an upright, package-like folded position with their undersides meeting one another in the storage compartment thereby exposing the vehicle interior. The lever mechanism includes first and second coupling gears which are interconnected to one another and are in mechanical linkage with the front roof part and the vehicle body with the first coupling gear being connected to the vehicle body and the second coupling gear being connected to the front roof part, each coupling gear forming a four-bar kinematic linkage system.

In accordance with embodiments of the present invention, a lever mechanism and linear guiding enable advantageous motion of the roof between the closed and opened positions. The roof, in particular the front roof part, undergoes an advantageous motion from the closed position to the opened position in which the roof parts are stowed in an upright, package-like folded position in the storage compartment within the vehicle interior. The lever mechanism may include a first coupling gear having multiple gear elements operable with a linear guide apparatus. Alternatively, the lever mechanism may include first and second interconnected coupling gears. Each lever mechanism is designed such that the roof parts move independently of the trunk lid of the vehicle trunk adjacent to the storage compartment thereby providing favorable opportunities for roof and trunk lid designs.

The above features, and other features and advantages of the present invention as readily apparent from the following detailed descriptions thereof when taken in connection with the accompanying drawings.

### BRIEF DESCRIPTION OF THE DRAWINGS

FIG. 1 illustrates a side view of a vehicle having a multipart roof in accordance with a first embodiment of the present invention with the roof in a closed position in which the roof parts cover the vehicle interior;

FIG. 2 illustrates a side view of the roof shown in FIG. 1 in an intermediate position between the closed position and an opened position;

FIG. 3 illustrates a side view of the roof shown in FIG. 1 in the opened position in which the roof parts are stowed in an upright, package-like folded position in a storage compartment within the vehicle interior thereby exposing the vehicle interior;

FIG. 4 illustrates a side view of a vehicle having a multipart roof in accordance with a second embodiment of the present invention with the roof in the closed position;

FIG. 5 illustrates a side view of the roof shown in FIG. 4 in a first intermediate position between the closed position and the opened position;

FIG. 6 illustrates a side view of the roof shown in FIG. 4 in a second intermediate position between the closed position and the opened position;

FIG. 7 illustrates a side view of the roof shown in FIG. 4 in the opened position;

FIG. 8 illustrates an enlarged view of detail X in FIG. 4;

FIG. 9 illustrates an enlarged view of detail Y in FIG. 4; and

FIG. 10 illustrates an enlarged view of detail Z in FIG. 4.

### DETAILED DESCRIPTION OF THE PREFERRED EMBODIMENT(S)

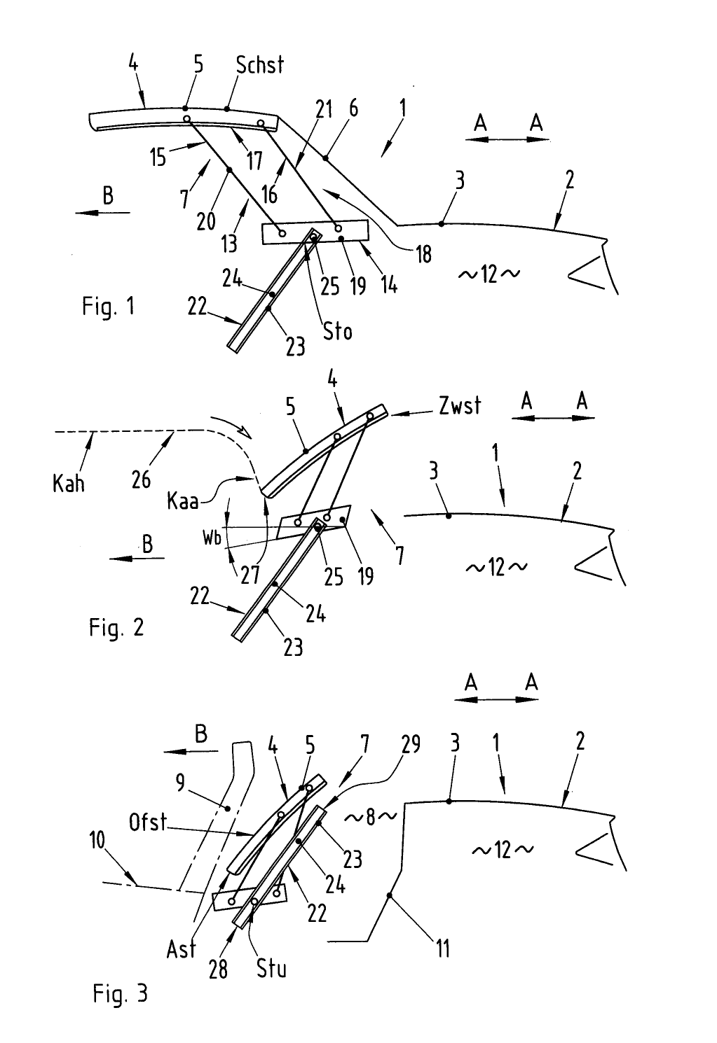

Referring now to FIGS. 1, 2, and 3, side views of a vehicle 1 having a multipart roof 4 in accordance with a first embodiment of the present invention are shown. Roof 4 includes a front roof part 5 and a rear roof part 6. Roof parts 5, 6 are movable relative to vehicle body 2 and are articulately connected to one another at the rear end of front roof part 5 and at the front end of rear roof part 6, as viewed in the forward direction of vehicle travel B. As such, movement of front roof part 5 causes a corresponding movement of rear roof part 6. In general, roof 4 is movable between a closed position Schst (shown in FIG. 1) and an opened position Ofst (shown in FIG. 3) via an intermediate position Zwst (shown in FIG. 2). In the closed position, roof parts 5, 6 extend over and cover the vehicle interior and are arranged flush behind one another with front roof part 5 in front of rear roof part 6 along the longitudinal vehicle direction A-A. In the opened position, roof parts 5, 6 are stowed in an upright, package-like folded position Ast with their undersides meeting one another in a storage compartment 8 within the vehicle interior thereby exposing the vehicle interior.

In addition to storage compartment 8 within the vehicle interior, vehicle 1 includes a trunk 12 in a rear portion of vehicle body 2. A movable trunk lid 3 is connected to vehicle body 2 to close and open trunk 12. The rear end of rear roof part 6 and the front end of trunk lid 12 face one another when roof 4 is in the closed position, as viewed in the forward direction of vehicle travel B. Rear roof part 6 and trunk lid 12 are independently movable of one another. Storage compartment 8 is located in front of trunk 12, as viewed in the forward direction of vehicle travel B. A transverse wall 11 of vehicle body 2 separates storage compartment 8 and trunk 12 from one another. Transverse wall 11 extends transverse to the longitudinal vehicle direction A-A. Storage compartment 8 is located within the vehicle interior behind a seat back 9 of a seat 10 within the vehicle interior and in front of transverse wall 11, as viewed in the forward direction of vehicle travel B. Seat back 9 and transverse wall 11 delimit roof parts 5, 6 when roof 4 is in the opened position.

A lever mechanism 7 movably connects roof 4 to vehicle body 2 to move roof 4 (i.e., roof parts 5, 6) between the closed and opened positions. Lever mechanism 7 includes a coupling gear 13 by which movement of roof parts 5, 6 between the closed and opened positions may be controlled. Coupling gear 13 includes multiple gear elements 14, 15, 16, and 17. Gear elements 14, 15, 16, and 17 form a four-bar kinematic linkage system 18 in mechanical linkage with vehicle body 2 and front roof part 5. Gear elements 14, 15, 16, and 17 cooperate with front roof part 5 and cooperate with a bearing 19. Bearing 19 corresponds to gear element 14 and gear element 17 corresponds to front roof part 5. Front roof part 5 and bearing 19 extend horizontally to one another when roof 4 is in the closed position.

Guide rods 20, 21 in the form of gear elements 15, 16 are oriented obliquely from top to bottom in the direction opposite the direction of forward vehicle travel B as viewed from the side of vehicle 1. Guide rods 20, 21 act between gear element 17 for front roof part 5 and guide element 14 for bearing 19. In particular, guide rods 20, 21 cooperate at one end with front roof part 5 and are supported at their other end with bearing 19.

A linear guide apparatus 22 cooperates with bearing 19. Linear guide apparatus 22 includes a guide rail 23 having a guide track 24. Linear guide apparatus 22 stands relatively upright within the vehicle interior and is fixed in place. A pin 25 fixed to bearing 19 is slidably engaged within guide track 24 such that pin 25 is upwardly and downwardly movable relative to guide track 24 between an upper position Sto and a lower position Stu upon appropriate forces greater than the weight of roof 4 being applied. As pin 25 is fixed to bearing 19, movement of pin 25 within guide track 24 causes a corresponding movement of bearing 19 relative to guide track 24 between upper position Sto and lower position Stu. Likewise, as bearing 19 is connected to front roof part 5 via coupling gear 13, the movement of bearing 19 causes a corresponding movement of front roof part relative to guide track 24 between upper position Sto and lower position Stu. Pin 25 (and thereby bearing 19 and roof 4) is lockable to guide track 24 in both upper position Sto and lower position Stu. Movement of roof 4 from the closed position to the intermediate position causes pin 25 to unlock from the upper position Sto. Pin 25 and bearing 19 may be operable with one another to produce angular motions Wb (see FIG. 2) of bearing 19 relative to guide track 24.

Due to the configuration between guide rods 20, 21, front roof part 5, and bearing 19, front roof part 5 is guided along a trajectory 26 when roof 4 is lowered from the closed position to the opened position. Trajectory 26 initially has a horizontal curved section Kah and then has a downwardly oriented curved section Kaa. A front edge 27 of front roof part 5 follows the downwardly oriented curved section Kaa. In addition, viewed in the direction of forward vehicle travel B, guide rail 23 is situated with its lower end 28 farther to the front than its upper end 29. When roof 4 is in the opened position, roof parts 5, 6 extend in the same slanted direction as guide rail 23 and are at the lower position Stu. Although lever mechanism 7 (i.e., coupling gear 13) moves roof 4 (i.e., roof parts 5, 6) between the closed and opened positions, this motion is completely independent of trunk lid 3.

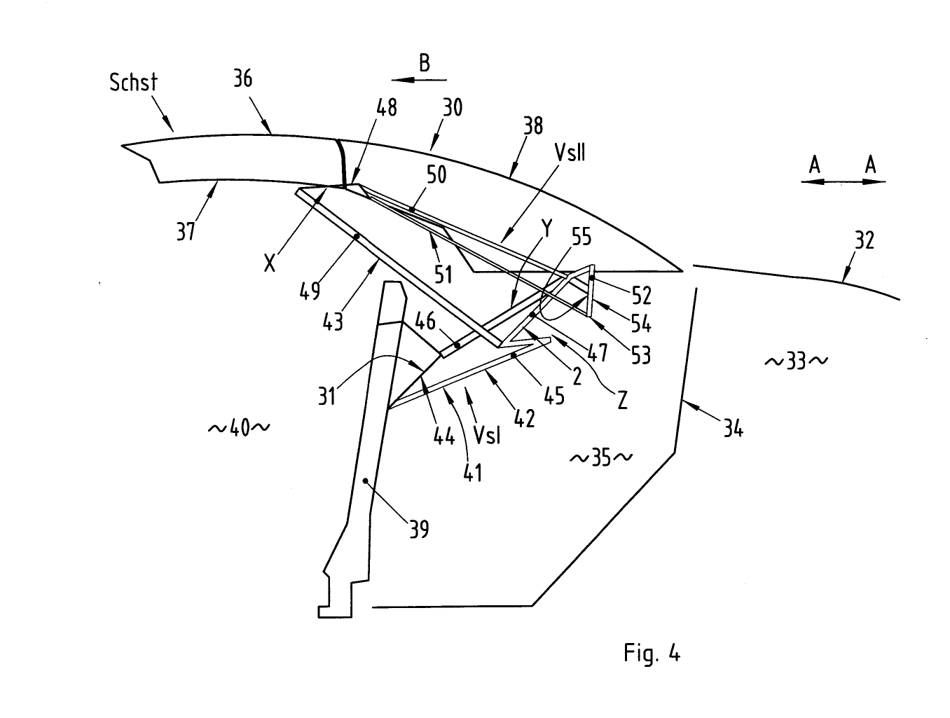

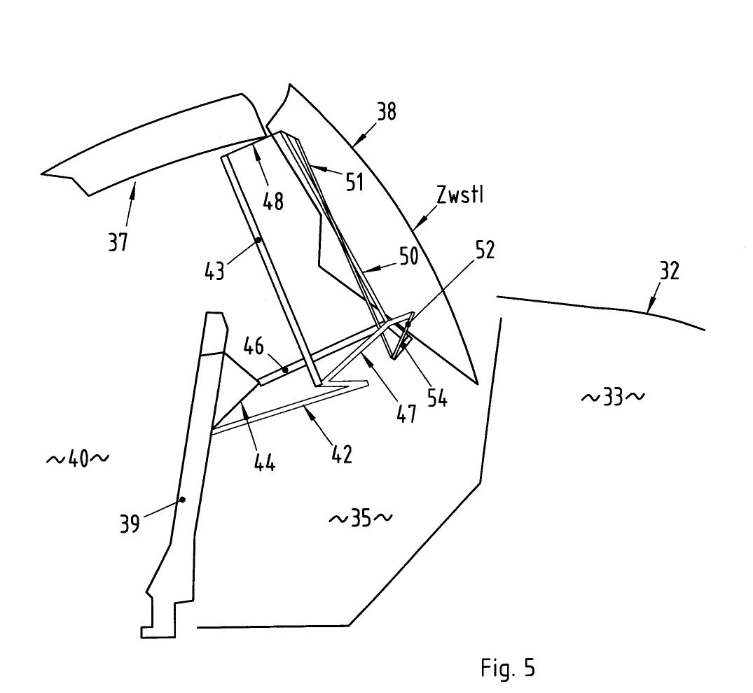

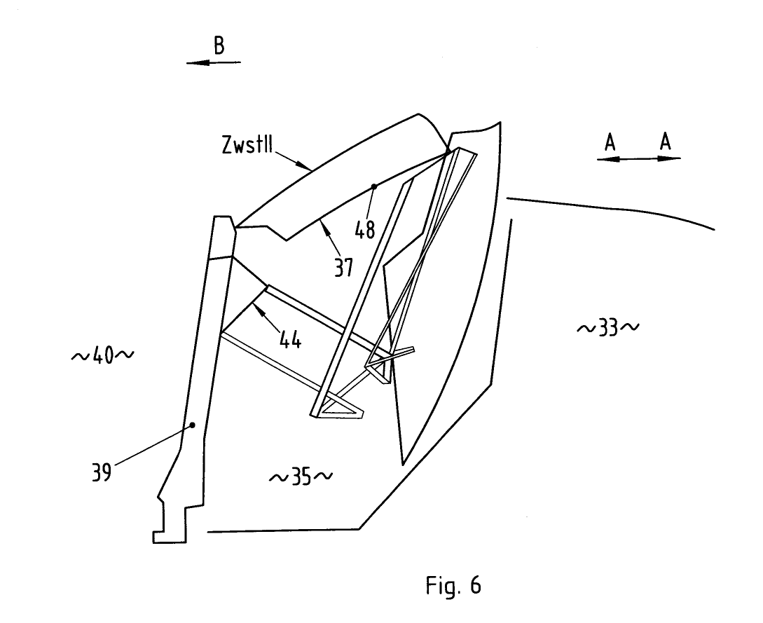

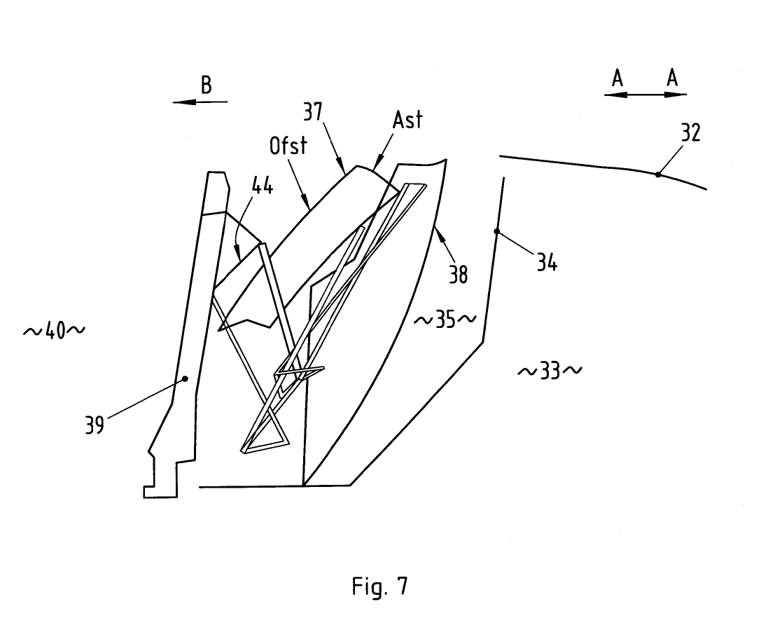

Referring now to FIGS. 4, 5, 6, and 7, side views of a vehicle 30 having a multipart roof 36 in accordance with a second embodiment of the present invention are shown. Roof 36 includes a front roof part 37 and a rear roof part 38. Roof parts 37, 38 are movable relative to vehicle body 31 and are articulately connected to one another at the rear end of front roof part 37 and at the front end of rear roof part 38, as viewed in the forward direction of vehicle travel B. As such, movement of front roof part 37 causes a corresponding movement of rear roof part 38. In general, roof 36 is movable between a closed position Schst (shown in FIG. 4) and an opened position Ofst (shown in FIG. 7) via a first intermediate position ZwstI (shown in FIG. 5) and a second intermediate position ZwstII (shown in FIG. 6). The first intermediate position is nearer the closed position and the second intermediate position is nearer the opened position. In the closed position, roof parts 37, 38 extend over and cover the vehicle interior and are arranged flush behind one another with front roof part 37 in front of rear roof part 38 along the longitudinal vehicle direction A-A. In the opened position, roof parts 37, 38 are stowed in an upright, package-like folded position Ast with their undersides meeting one another in a storage compartment 35 within the vehicle interior thereby exposing the vehicle interior.

In addition to storage compartment 35, vehicle 30 includes a trunk lid 32 spanning a trunk 33. The rear end of rear roof part 38 and the front end of trunk lid 32 face one another when roof 36 is in the closed position, as viewed in the forward direction of vehicle travel B. Rear roof part 38 and trunk lid 32 are independently movable of one another. Storage compartment 35 is located in front of trunk 33, as viewed in the forward direction of vehicle travel B. A partition wall 34 running transverse to longitudinal vehicle direction A-A extends between storage compartment 35 and trunk 33. Storage compartment 35 is located within the vehicle interior behind a seat back 39 of a passenger compartment 40 within the vehicle interior and in front of partition wall 34, as viewed in the forward direction of vehicle travel B. Seat back 39 and partition wall 34 delimit roof parts 37, 38 when roof 36 is in the opened position.

A lever mechanism 41 movably connects roof 36 to vehicle body 31 to move roof 36 (i.e., roof parts 37, 38) between the closed and opened positions. Lever mechanism 41 includes a first coupling gear 42 and a second coupling gear 43. Coupling gears 42, 43 are interconnected to one another and act between vehicle body 31 and front roof part 37 to move roof parts 37, 38 between the closed and opened positions independent of the movement of trunk lid 32.

First and second coupling gears 42, 43 are in the form of first and second four-bar kinematic linkage systems VsI, VsII, respectively. First coupling gear 42 cooperates with vehicle body 31 and second coupling gear 43 cooperates with front roof part 37. First coupling gear 42 includes a first fixed member 44 mounted on vehicle body 31, first and second longitudinal members 45, 46 which cooperate with first fixed member 44, and an intermediate member 47. Second coupling gear 43 includes a second fixed member 48 attached to front roof part 37 and third and fourth longitudinal members 49, 50 linked to second fixed member 48. Third longitudinal member 49 is connected to intermediate member 47 of first coupling gear 42, and fourth longitudinal member 50 is connected to second longitudinal member 46 and to intermediate member 47 of first coupling gear 42.

A coupling rod 51 engages second fixed member 48 and is connected to intermediate member 47 via a guide rod 52. Coupling rod 51 and guide rod 52 cooperate with a first end 53 of a drive rod 54. A second end 55 of drive rod 54 is connected to second longitudinal member 46.

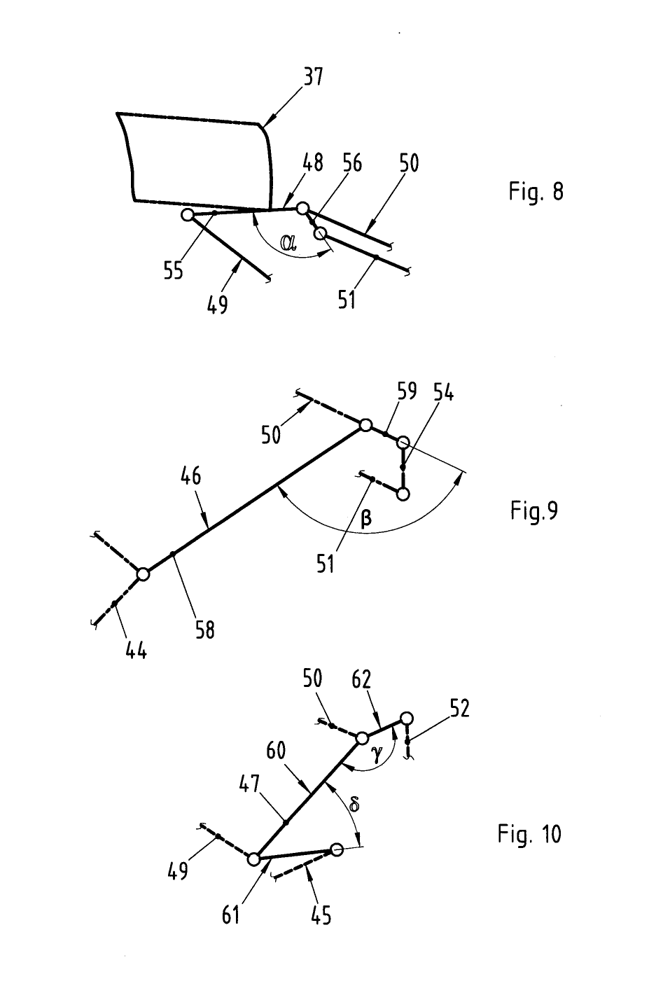

Referring now to FIG. 8, an enlarged view of detail X in FIG. 4 is shown. Second fixed member 48 is attached to front roof part 37. Second fixed member 48 is a two-armed lever having a first lever section 55 for third and fourth longitudinal members 49, 50 and a second lever section 56 for coupling rod 51. First lever section 55 and second lever section 56 define an obtuse angle α with respect to one another.

Referring now to FIG. 9, an enlarged view of detail Y in FIG. 4 is shown. Second longitudinal member 46 is a two-armed lever having first and second lever sections 58 and 59. One end of first lever section 58 is in mechanical linkage with first fixed member 44 and the other end of first lever section 58 is in mechanical linkage with fourth longitudinal member 50. Drive rod 54 engages with the free end of second lever section 59. First lever section 58 and second lever section 59 converge at an obtuse angle β with respect to one another.

Referring now to FIG. 10, an enlarged view of detail Z in FIG. 4 is shown. Intermediate member 47 is a three-armed lever having lever sections 60, 61, and 62. Third and fourth longitudinal members 49, 50 are connected to lever section 60. First longitudinal member 45 and guide rod 52 cooperate with free ends of lever sections 61 and 62, respectively. Lever section 60 and lever section 61 define an acute angle δ with respect to one another, and lever section 60 and lever section 62 define an obtuse angle γ with respect to one another.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A vehicle comprising:
a roof having a front roof part and a rear roof part articulately connected together such that movement of the front roof part causes a corresponding movement of the rear roof part;
a linear guide apparatus fixed to the vehicle body within a storage compartment of the vehicle interior; and
a lever mechanism movably connecting the front roof part to the linear guide apparatus to move the roof parts between a closed position in which the roof parts extend over and cover the vehicle interior and an opened position in which the roof parts are stowed in an upright, package-like folded position with their undersides meeting one another in the storage compartment thereby exposing the vehicle interior;
wherein the lever mechanism includes a coupling gear having first, second, third, and fourth gear elements forming a four-bar kinematic linkage system in mechanical linkage with the front roof part and the linear guide apparatus, wherein the first gear element is supported on the front roof part, the second and third gear elements extend between the front roof part and the fourth gear element, and the fourth gear element slidably engages the linear guide apparatus to be movable between an upper position corresponding to the roof being in the closed position and a lower position corresponding to the roof being in the opened position.

2. The vehicle of claim 1 wherein:
the second and third gear elements are guide rods and the fourth gear element is a bearing having a pin.

3. The vehicle of claim 2 wherein:
the linear guide apparatus includes a guide rail in which the pin of the bearing is movable to move the roof between the upper position corresponding to the roof being in the closed position and the lower position corresponding to the roof being in the opened position.

4. The vehicle of claim 3 wherein:
the guide rail is oriented relatively upright.

5. The vehicle of claim 4 wherein:
the guide rail has a lower end and an upper end with the lower end farther to the front of the vehicle than the upper end.

6. The vehicle of claim 3 wherein:
the roof parts extend in the same direction as the guide rail when the roof is in the opened position.

7. The vehicle of claim 1 wherein:
the front roof part and the rear roof part move independently of a trunk lid of the vehicle body.

8. A vehicle comprising:
a roof having a front roof part and a rear roof part articulately connected together such that movement of the front roof part causes a corresponding movement of the rear roof part; and
a lever mechanism movably connecting the front roof part to the vehicle body to move the roof parts between a closed position in which the roof parts extend over and cover the vehicle interior and an opened position in which the roof parts are stowed in an upright, package-like folded position with their undersides meeting one another in the storage compartment thereby exposing the vehicle interior;
wherein the lever mechanism includes first and second coupling gears which are interconnected to one another and are in mechanical linkage with the front roof part and the vehicle body with the first coupling gear being connected to the vehicle body and the second coupling gear being connected to the front roof part, each coupling gear forming a four-bar kinematic linkage system.

9. The vehicle of claim 8 wherein:
the first coupling gear has a first fixed member mounted on the vehicle body, first and second longitudinal members linked to the first fixed member, and an intermediate member.

10. The vehicle of claim 9 wherein:
the second coupling gear includes a second fixed member attached to the front roof part and third and fourth longitudinal members linked to the second fixed member, the third longitudinal member being connected to the intermediate member of the first coupling gear, and the fourth longitudinal member being connected to the second longitudinal member of the first coupling gear.

11. The vehicle of claim 10 wherein:
a coupling rod engages with the second fixed member and is connected to the intermediate member via a guide rod.

12. The vehicle of claim 11 wherein:
the coupling rod and the guide rod cooperate with a first end of a drive rod, a second end of the drive rod being connected to the second longitudinal member.

13. The vehicle of claim 8 wherein:
the front roof part and the rear roof part move independently of a trunk lid of the vehicle body.

14. A roof for a vehicle comprising:
a front roof part and a rear roof part articulately connected together such that movement of the front roof part causes a corresponding movement of the rear roof part;
a fixed linear guide apparatus; and
a lever mechanism movably connecting the front roof part to the linear guide apparatus to move the roof parts between a closed position in which the roof parts extend from one another at an upper position an opened position in which the roof parts are in an upright, package-like folded position with their undersides meeting one another in a lower position;
wherein the lever mechanism includes a coupling gear having first, second, third, and fourth gear elements forming a four-bar kinematic linkage system in mechanical linkage with the front roof part and the linear guide apparatus, wherein the first gear element is supported on the front roof part, the second and third gear elements extend between the front roof part and the fourth gear element, and the fourth gear element slidably engages the linear guide apparatus to be movable between the upper position corresponding to the roof being in the closed position and the lower position corresponding to the roof being in the opened position.

15. The roof of claim 14 wherein:
the second and third gear elements are guide rods and the fourth gear element is a bearing having a pin.

16. The roof of claim 15 wherein:
the linear guide apparatus includes a guide rail in which the pin of the bearing is movable to move the roof between the upper position corresponding to the roof being in the closed position and the lower position corresponding to the roof being in the opened position.

17. The roof of claim 16 wherein:
the guide rail is oriented relatively upright.

18. The roof of claim 17 wherein:
the guide rail has a lower end and an upper end with the lower end in front of the upper end.

19. The roof of claim 14 wherein:
the roof parts extend in the same direction as the guide rail when the roof is in the opened position.

20. The roof of claim 14 wherein:
the front roof part and the rear roof part move independently of a vehicle trunk lid.
